(19) United States
(12) Patent Application Publication
(10) Pub. No.: US 2023/0318869 A1
(43) Pub. Date: Oct. 5, 2023

(54) SYSTEMS AND METHODS FOR LATENT MONITORING OF CONNECTED HOME APPLIANCES

(71) Applicant: Haier US Appliance Solutions, Inc., Wilmington, DE (US)

(72) Inventor: Wei Zhou, Louisville, KY (US)

(21) Appl. No.: 17/713,620

(22) Filed: Apr. 5, 2022

(51) Int. Cl. H04L 12/28

(52) U.S. Cl. CPC H04L 12/2825

(57) ABSTRACT

A method of monitoring a plurality of home appliances includes performing an operating cycle of a home appliance of the plurality of home appliances while transmitting a data stream from the home appliance to a remote computing device during the operating cycle. The method further includes analyzing, by the remote computing device, performance of the home appliance in real time during the operating cycle using the data stream.

### FIELD OF THE INVENTION

The present subject matter relates generally to home appliances with internet connectivity features and to systems and methods for monitoring data streams generated by such appliances.

### BACKGROUND OF THE INVENTION

Home appliances are increasingly becoming more interconnected, for instance, with each other and with internet-connected devices. Further, home appliances are increasingly utilizing machine learning artificial intelligence to perform computations related to performance, options, maintenance, and the like. Generally, the computing power required to perform these computations is beyond what is typically installed in most home appliances. Accordingly, the information on which of these computations is performed may be sent to the cloud or a cloud computing server, where results are calculated and transmitted back to the appliance.

These current methods have several drawbacks. For instance, as the sophistication, number, and variety of home appliances connected to the cloud increases, the volume of data transmitted to, processed by, and/or stored in the cloud also increases, along with the associated costs. Thus, in some cases, real-time analysis of the data, given such volume of data, may not be feasible.

Accordingly, there exists a need for systems and methods with streamlined data analysis, such as for tracking performance anomalies or usage patterns in a live environment for numerous home appliances.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of monitoring a plurality of home appliances is provided. The method includes performing an operating cycle of a home appliance of the plurality of home appliances and transmitting a data stream from the home appliance to a remote computing device during the operating cycle. The method also includes constructing, by the remote computing device, an appliance performance result matrix based on the data stream in real time. The method further includes analyzing, by the remote computing device, performance of the home appliance in real time during the operating cycle using the appliance performance result matrix. Analyzing the performance of the home appliance using the appliance performance result matrix comprises decomposing the appliance performance result matrix into a first latent matrix and a second latent matrix.

In accordance with another embodiment of the present disclosure, a method of monitoring a plurality of home appliances is provided. The method includes performing an operating cycle of a home appliance of the plurality of home appliances and transmitting a data stream from the home appliance to a remote computing device during the operating cycle. The method also includes analyzing, by the remote computing device, performance of the home appliance in real time during the operating cycle using the data stream.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a front view of a dishwashing appliance in accordance with additional exemplary embodiments of the present disclosure.

FIG. 5 provides a transverse cross-sectional view of the dishwashing appliance of FIG. 4.

FIG. 6 provides a perspective view of an oven appliance according to one or more exemplary embodiments of the present subject matter.

FIG. 7 provides a transverse cross-sectional view of the oven appliance of FIG. 6 taken along line 2-2 of FIG. 6.

FIG. 8 provides an illustration of construction of an appliance performance result matrix according to one or more exemplary embodiments of the present disclosure.

FIG. 9 provides another illustration of construction of an appliance performance result matrix according to one or more exemplary embodiments of the present disclosure.

FIG. 10 provides an illustration of latent matrix factorization according to one or more further exemplary embodiments of the present disclosure.

FIG. 11 provides an illustration of construction of a unit cycle characteristics similarity matrix according to one or more exemplary embodiments of the present disclosure.

FIG. 12 provides a schematic diagram of a system for monitoring a plurality of home appliances according to one or more exemplary embodiments of the present disclosure.

FIG. 13 provides a flow diagram of a method of monitoring a plurality of home appliances according to one or more exemplary embodiments of the present disclosure.

FIG. 14 provides a flow diagram of another method of monitoring a plurality of home appliances according to one or more additional exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

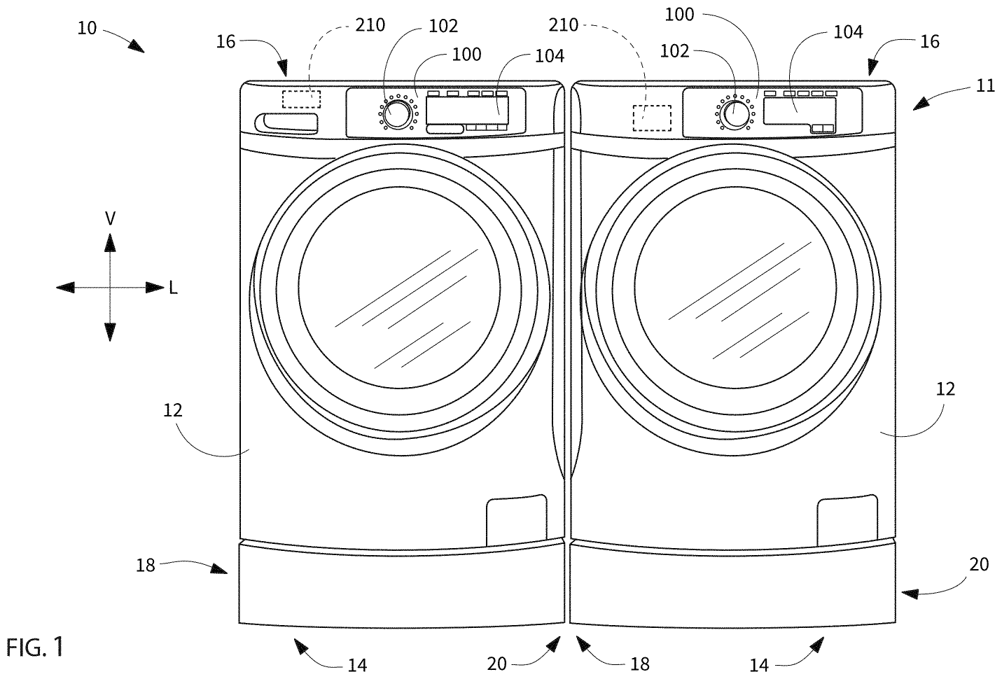

As may be seen in FIGS. 1 through 7, in accordance with one or more embodiments of the present subject matter, a home appliance is provided. Specific examples of such home appliances are each described in turn below to illustrate various aspects and embodiments of the present disclosure. However, it should be understood that such examples are non-limiting and the home appliance of the present disclosure may include a variety of appliances with various features operable to perform home and/or domestic tasks.

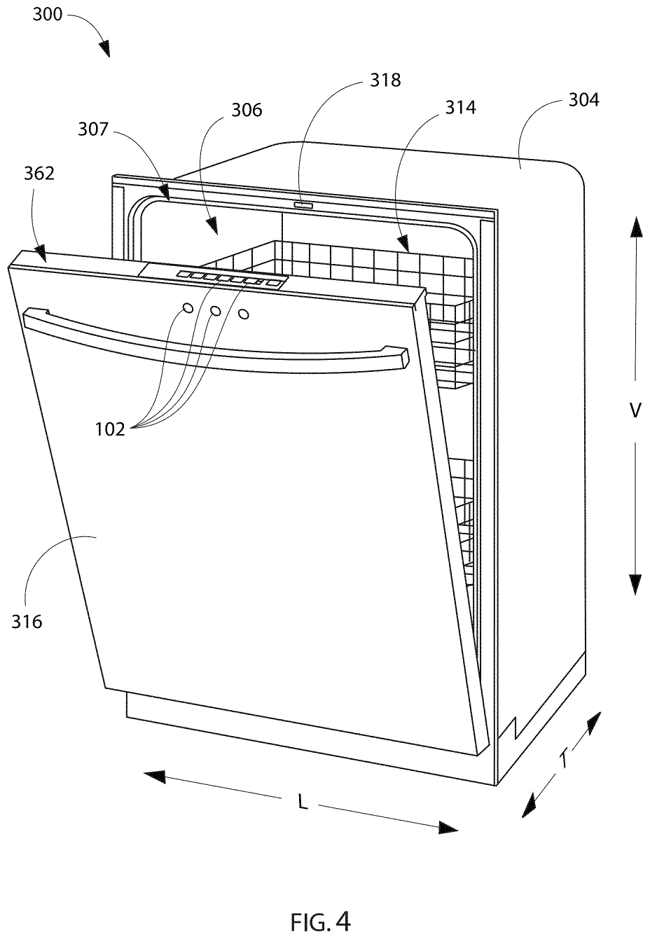

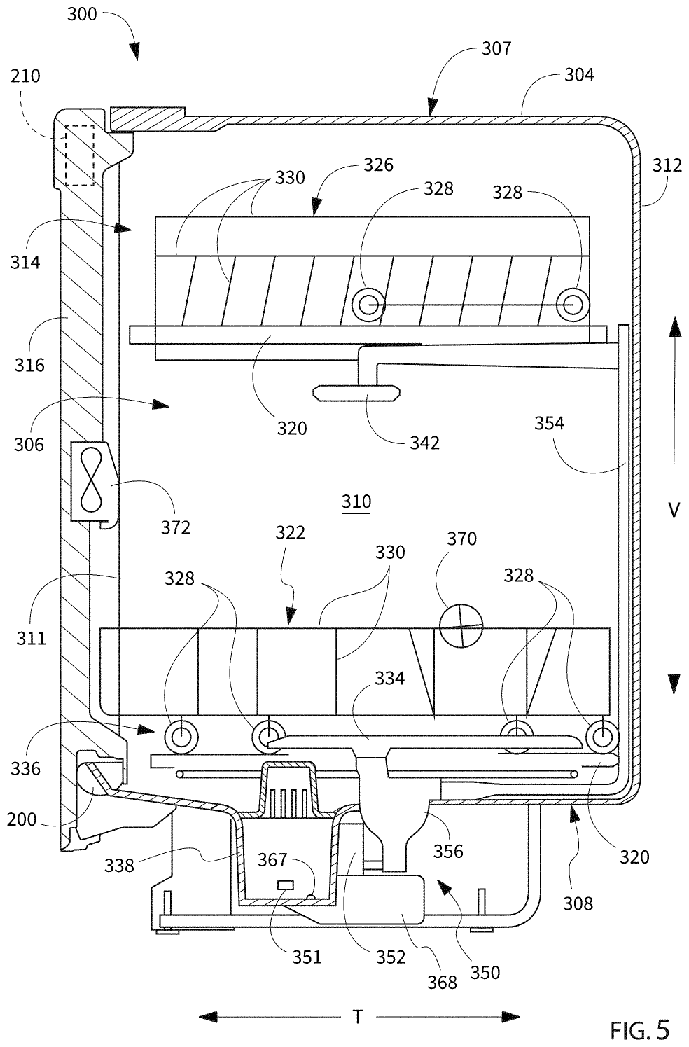

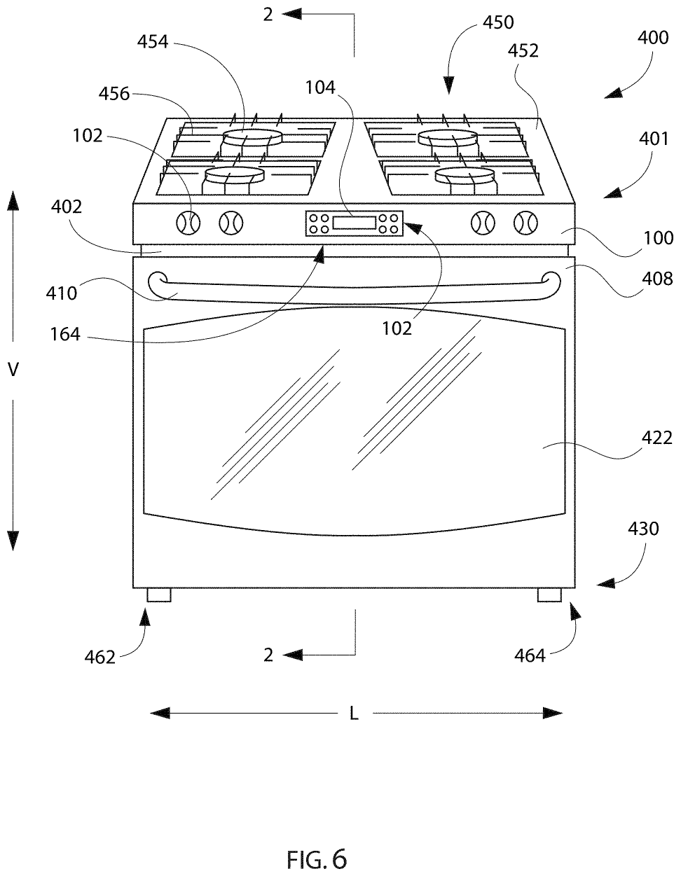

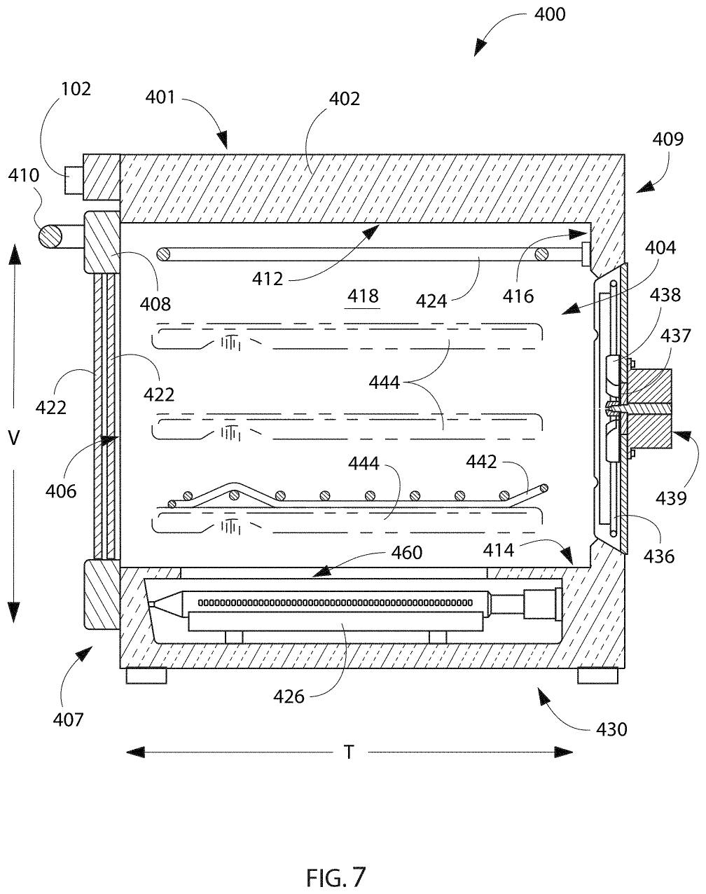

It should be understood that “home appliance” and/or “appliance” are used herein to describe appliances typically used or intended for common domestic tasks, such as a laundry appliance, e.g., as illustrated in FIGS. 1 through 3, or a dishwasher appliance (see, e.g., FIGS. 4 and 5), an oven appliance (see, e.g., FIGS. 6 and 7), a refrigerator, a water heater, etc., and any other home appliance which performs similar functions in addition to network communication and data processing. Thus, devices such as a personal computer, router, and other similar devices the primary functions of which are network communication and/or data processing are not considered home appliances as used herein.

As may be seen generally throughout FIGS. 1 through 7, a user interface panel 100 and a user input device 102 may be positioned on an exterior of the appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, the appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, either appliance or both appliances of a pair of laundry appliances 10 and 11 may be the home appliance. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each home appliance 10 and 11.

As generally seen throughout FIGS. 1 through 3, in at least some embodiments, each appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

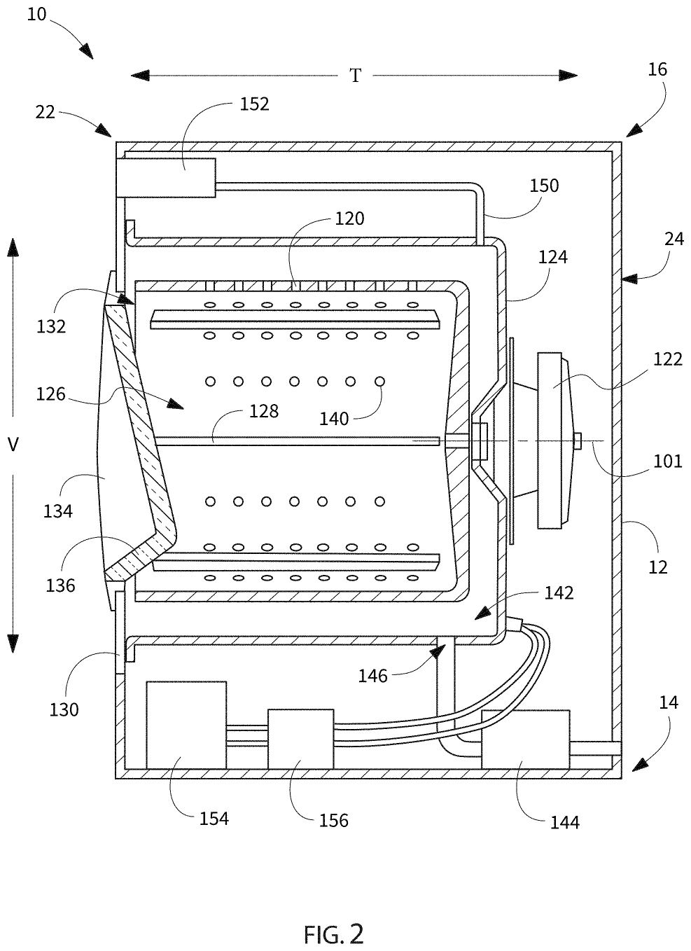

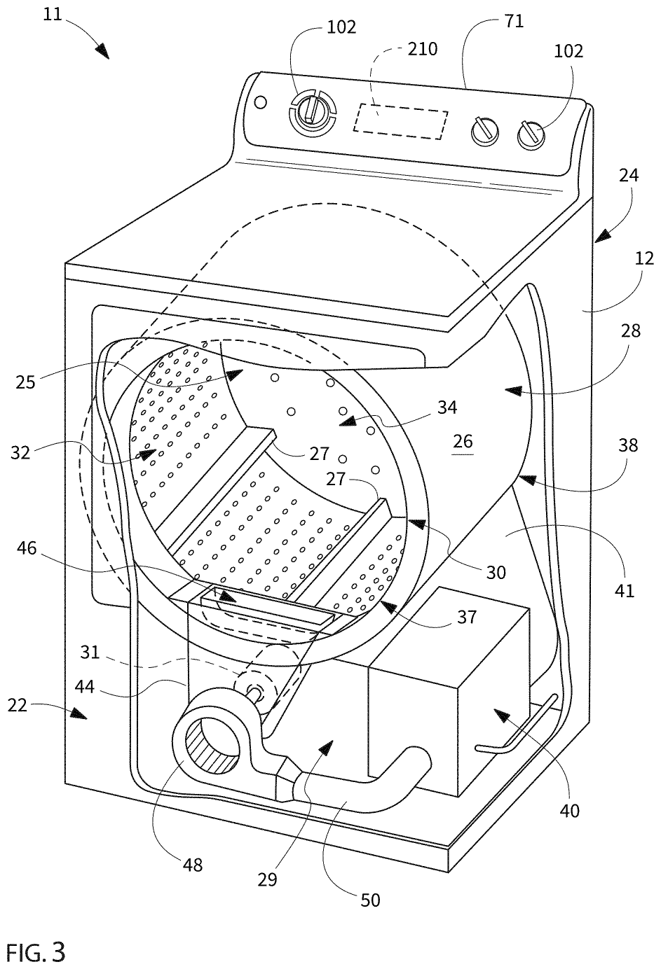

Additional exemplary details of the laundry appliances are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a home appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

Turning now to FIGS. 4 and 5, in some embodiments, the home appliance may be a dishwasher or dishwashing appliance, such as the exemplary dishwashing appliance 300, that may be configured in accordance with aspects of the present disclosure. Generally, dishwasher 300 defines a vertical direction V, a lateral direction L, and a transverse direction T. Each of the vertical direction V, lateral direction L, and transverse direction T are mutually perpendicular to one another and form an orthogonal direction system.

Dishwasher 300 includes a tub 304 that defines a wash chamber 306 therein. As shown in FIG. 5, tub 304 extends between a top 307 and a bottom 308 along the vertical direction V, between a pair of side walls 310 along the lateral direction L, and between a front side 311 and a rear side 312 along the transverse direction T.

Tub 304 includes a front opening 314 at the front side 311. In some embodiments, the dishwashing appliance 300 may also include a door 316 at the front opening 314. The door 316 may, for example, be coupled to the tub 304 by a hinge 200 at its bottom for movement between a normally closed vertical position (FIG. 5), wherein the wash chamber 306 is sealed shut for washing operation, and a horizontal open position (not shown, while a partially open position is illustrated in FIG. 4) for loading and unloading of articles from dishwasher 300. A door closure mechanism or assembly 318, e.g., a latch, may be provided to lock and unlock door 316 for accessing and sealing wash chamber 306.

In exemplary embodiments, tub side walls 310 accommodate a plurality of rack assemblies. For instance, guide rails 320 may be mounted to side walls 310 for supporting a lower rack assembly 322 and an upper rack assembly 326. In some such embodiments, upper rack assembly 326 is positioned at a top portion of wash chamber 306 above lower rack assembly 322 along the vertical direction V.

Generally, each rack assembly 322, 326 may be adapted for movement between an extended loading position (not shown) in which the rack is substantially positioned outside the wash chamber 306, and a retracted position (shown in FIG. 5) in which the rack is located inside the wash chamber 306. In some embodiments, movement is facilitated, for instance, by rollers 328 mounted onto rack assemblies 322, 326, respectively.

Although guide rails 320 and rollers 328 are illustrated herein as facilitating movement of the respective rack assemblies 322, 326, it should be appreciated that any suitable sliding mechanism or member may be used according to alternative embodiments.

In optional embodiments, some or all of the rack assemblies 322, 326 are fabricated into lattice structures including a plurality of wires or elongated members 330 (for clarity of illustration, not all elongated members making up rack assemblies 322, 326 are shown). In this regard, rack assemblies 322, 326 are generally configured for supporting articles within wash chamber 306 while allowing a flow of wash liquid to reach and impinge on those articles (e.g., during a cleaning or rinsing cycle). According to additional or alternative embodiments, a silverware basket (not shown) may be removably attached to a rack assembly (e.g., lower rack assembly 322), for placement of silverware, utensils, and the like, that are otherwise too small to be accommodated by the rack assembly.

Generally, dishwasher 300 includes one or more spray assemblies for urging a flow of fluid (e.g., wash liquid) onto the articles placed within wash chamber 306.

In exemplary embodiments, dishwasher 300 includes a lower spray arm assembly 334 disposed in a lower region 336 of wash chamber 306 and above a sump 338 so as to rotate in relatively close proximity to lower rack assembly 322. In this regard, lower spray arm assembly 334 may generally be configured for urging a flow of wash liquid up through lower rack assembly 322.

In some embodiments, an upper spray assembly 342 may be located proximate to and, e.g., below, upper rack assembly 326 along the vertical direction V.

In this manner, upper spray assembly 342 may be generally configured for urging of wash liquid up through upper rack assembly 326.

The various spray assemblies and manifolds described herein may be part of a fluid distribution system or fluid circulation assembly 350 for circulating wash liquid in tub 304. In certain embodiments, fluid circulation assembly 350 includes a circulation pump 352 for circulating wash liquid in tub 304. Circulation pump 352 may be mounted to sump 338 and in fluid communication with the sump 338 through a circulation outlet 351 from the sump 338.

When assembled, circulation pump 352 may be in fluid communication with an external water supply line (not shown) and sump 338. A water inlet valve (not shown) can be positioned between the external water supply line and circulation pump 352 (e.g., to selectively allow water to flow from the external water supply line to circulation pump 352). Additionally or alternatively, water inlet valve can be positioned between the external water supply line and sump 338 (e.g., to selectively allow water to flow from the external water supply line to sump 338). During use, water inlet valve may be selectively controlled to open to allow the flow of water into dishwasher 300 and may be selectively controlled to close and thereby cease the flow of water into dishwasher 300. Further, fluid circulation assembly 350 may include one or more fluid conduits or circulation piping for directing wash fluid from circulation pump 352 to the various spray assemblies and manifolds. In exemplary embodiments, such as that shown in FIG. 5, a primary supply conduit 354 extends from circulation pump 352, along rear side 312 of tub 304 along the vertical direction V to supply wash liquid throughout wash chamber 306.

In optional embodiments, circulation pump 352 urges or pumps wash liquid to a diverter 356 (FIG. 5). In some such embodiments, diverter 356 is positioned within sump 338 of dishwashing appliance 300). Diverter 356 may include a diverter disk (not shown) disposed within a diverter chamber 358 for selectively distributing the wash liquid to the spray assemblies 334, 342, or other spray manifolds or assemblies. For instance, the diverter disk may have at least one aperture configured to align with one or more outlet ports (not shown) at the top of diverter chamber 358. In this manner, the diverter disk may be selectively rotated to provide wash liquid to the desired spray device(s).

In exemplary embodiments, diverter 356 is configured for selectively distributing the flow of wash liquid from circulation pump 352 to various fluid supply conduits—only some of which are illustrated in FIG. 5 for clarity. In certain embodiments, diverter 356 includes two or more outlet ports (not shown) for supplying wash liquid to a first conduit for rotating lower spray arm assembly 334 and a second conduit for supplying upper spray assembly 342 (e.g., supply conduit 354). Additional embodiments may also include one or more additional conduits, e.g., a third conduit for spraying an auxiliary rack such as a silverware rack, etc.

In some embodiments, a supply conduit 354 is used to supply wash liquid to one or more spray assemblies (e.g., to upper spray assembly 342). It should be appreciated, however, that according to alternative embodiments, any other suitable plumbing configuration may be used to supply wash liquid throughout the various spray manifolds and assemblies described herein. For instance, according to another exemplary embodiment, supply conduit 354 could be used to provide wash liquid to lower spray arm assembly 334 and a dedicated secondary supply conduit (not shown) could be utilized to provide wash liquid to upper spray assembly 342. Other plumbing configurations may be used for providing wash liquid to the various spray devices and manifolds at any location within dishwashing appliance 300.

Each spray assembly 334 and 342, or other spray device as may be included in dishwashing appliance 300, may include an arrangement of discharge ports or orifices for directing wash liquid received from circulation pump 352 onto dishes or other articles located in wash chamber 306. The arrangement of the discharge ports, also referred to as jets, apertures, or orifices, may provide a rotational force by virtue of wash liquid flowing through the discharge ports. Alternatively, spray assemblies 334, 342 may be motor-driven, or may operate using any other suitable drive mechanism. Spray manifolds and assemblies may also be stationary. The resultant movement of the spray assemblies 334, 342 and the spray from fixed manifolds provides coverage of dishes and other dishwasher contents with a washing spray. Other configurations of spray assemblies may be used as well. For instance, dishwasher 300 may have additional spray assemblies for cleaning silverware, for scouring casserole dishes, for spraying pots and pans, for cleaning bottles, etc.

Drainage of soiled wash liquid within sump 338 may by provided, for instance, by a drain pump 368 (e.g., during or as part of a drain cycle). In particular, wash liquid may exit sump 338 through a drain outlet 367 and may flow through a drain conduit or directly to the drain pump 368. Thus, drain pump 368 is downstream of sump 338 and facilitates drainage of the soiled wash liquid by urging or pumping the wash liquid to a drain line external to dishwasher 300.

In some embodiments, a filter assembly may be provided, e.g., in the sump 338 and/or at a top entrance into the sump 338, e.g., to filter fluid to circulation assembly 350 and/or drain pump 368. Generally, the filter assembly removes soiled particles from the liquid that flows to the sump 338 from the wash chamber 306 during operation of dishwashing appliance 300. In exemplary embodiments, the filter assembly may include both a first filter (also referred to as a “coarse filter”) and a second filter (also referred to as a “fine filter”).

Although a separate circulation pump 352 and drain pump 368 are described herein, it is understood that other suitable pump configurations (e.g., using only a single pump for both recirculation and draining) may be provided.

Dishwashing appliance 300 may also include ventilation features, e.g., to promote improved, e.g., more rapid, drying of articles therein after the wash and rinse cycles. For example, one or more vents 370 may be provided in the tub 304 for introducing relatively dry air from outside of the tub 304 into the wash chamber 306 and/or for removing relatively humid air from the wash chamber 306 to the outside of the tub 304. In some embodiments, a fan 372 may be provided. The fan 372 may be operable to urge air through the wash chamber 306, such as to promote air circulation and/or ventilation within and through the wash chamber. Such air movement may increase the rate of evaporation of moisture from articles in the wash chamber 306 after a wash and/or rinse cycle.

In certain embodiments, dishwasher 300 includes a controller 210 configured to regulate operation of dishwasher 300 (e.g., initiate one or more wash operations). Controller 210 may include one or more memory devices and one or more microprocessors, etc., as described above. It should be noted that controllers as disclosed herein are capable of and may be operable to perform any methods and associated method steps as disclosed herein.

Controller 210 may be positioned in a variety of locations throughout dishwasher 300. In optional embodiments, controller 210 is located within a control panel area 362 of door 316 (e.g., as shown in FIG. 4). Input/output (“I/O”) signals may be routed between the control system and various operational components of dishwasher 300 along wiring harnesses that may be routed through the bottom of door 316. Typically, the controller 210 includes or is operatively coupled to a user interface panel/controls 102 through which a user may select various operational features and modes and monitor progress of dishwasher 300. In some embodiments, the user interface includes a general purpose I/O (“GPIO”) device or functional block. In additional or alternative embodiments, user interface includes input components, such as one or more of a variety of electrical, mechanical or electro-mechanical input devices including rotary dials, push buttons, and touch pads. In further additional or alternative embodiments, the user interface may include a display component, such as a digital or analog display device designed to provide operational feedback to a user. When assembled, the user interface may be in operative communication with the controller 210 via one or more signal lines or shared communication busses.

It should be appreciated that the invention is not limited to any particular style, model, or configuration of dishwasher 300. The exemplary embodiments depicted in FIGS. 4 and 5 are for illustrative purposes only. For instance, different locations may be provided for user input devices 102, different configurations may be provided for rack assemblies 322, 326, different spray assemblies 334, 342 and spray manifold configurations may be used, different sensors may be used, and other differences may be applied while remaining within the scope of the present disclosure.

FIGS. 6 and 7 illustrate another exemplary home appliance, which in this example is an oven appliance 400 according to an exemplary embodiment of the present subject matter. Oven appliance 400 includes an insulated cabinet 402 which defines a vertical direction V, a lateral direction L, and a transverse direction T. The vertical, lateral, and transverse directions V, L, and T are mutually perpendicular and form an orthogonal direction system. Cabinet 402 extends between a top portion 401 and a bottom portion 430 along the vertical direction V. Cabinet 402 extends between a left side 462 and a right side 464 along the lateral direction L and between a front portion 407 and a back portion 409 along the transverse direction T.

As shown in FIG. 6, oven appliance 400 includes a cooktop 450. Cooktop 450 is disposed on and is attached to or integral with cabinet 402. Cooktop 450 includes a top panel 452, which by way of example may be constructed of glass, ceramics, enameled steel, or combinations thereof. One or more burners 454 extend through top panel 452. A utensil (e.g., pots, pans, etc.) holding food and/or cooking liquids (e.g., oil, water, etc.) may be placed onto grates 456 disposed adjacent burners 454. Burners 454 provide thermal energy to cooking utensils placed on grates 456. Burners 454 can be any suitable type of burners, including e.g., gas, electric, electromagnetic, a combination of the foregoing, etc. It will be appreciated that the configuration of cooktop 450 is provided by way of example only and that other suitable configurations are contemplated.

Still referring to FIGS. 6 and 7, for this exemplary embodiment, oven appliance 400 includes an insulated cabinet 402 with an interior cooking chamber 404 defined by a top wall 412, a floor or bottom wall 414, a back wall 416, and a pair of opposing side walls 418. Cooking chamber 404 is configured for the receipt of one or more food items to be cooked. Oven appliance 400 includes a door 408 pivotally mounted to cabinet 402 at the opening 406 of cabinet 402 to permit selective access to cooking chamber 404 through opening 406. A handle 41 is mounted to door 408 and assists a user with opening and closing door 408. For example, a user can pull on handle 410 to open or close door 408 and access cooking chamber 404.

Oven appliance 400 can include a seal (not shown) between door 408 and cabinet 402 that assists with maintaining heat and cooking vapors within cooking chamber 404 when door 408 is closed as shown in FIGS. 6 and 7. Multiple parallel glass panes 422 provide for viewing the contents of cooking chamber 404 when door 408 is closed and assist with insulating cooking chamber 404. A baking rack 442 is positioned in cooking chamber 404 for the receipt of food items or utensils containing food items. Baking rack 442 is slidably received onto embossed ribs or sliding rails 444 such that rack 442 may be conveniently moved into and out of cooking chamber 404 when door 408 is open.

One or more heating elements may be included at the top, bottom, or both of cooking chamber 404 to provide heat to cooking chamber 404 for cooking. Such heating element(s) can be gas, electric, microwave, or a combination thereof. For example, in the embodiment shown in FIG. 7, oven appliance 400 includes a top heating element 424 which, in the illustrated example embodiment is an electric resistance heating element 424, and a bake heating element or bottom heating element 426, which, in the illustrated example embodiment is a gas burner 426, and bottom heating element 426 is positioned adjacent to and below bottom wall 414.

Also as may be seen in FIG. 7, the gas burner 426 is positioned within the cabinet 402 and outside of the chamber 404. In some embodiments, for example as illustrated in FIG. 7, the gas burner 426 may be a bake heating element or bottom heating element and may be positioned below the chamber 404 and separated from the chamber 404 by a partition, e.g., the bottom wall 414 of the chamber 404. The gas burner 426 may be in thermal communication and in fluid communication with the chamber by a flow path extending through one or more apertures or openings 460 in the bottom wall 414. In at least some embodiments, the flow path may extend from the gas burner 426, e.g., from ports thereof, through the opening(s) 460, and into the cooking chamber 404.

In the illustrated example embodiment, oven appliance 400 also has a convection heating element 436 and convection fan 438 positioned adjacent back wall 416 of cooking chamber 404. Convection fan 438 is powered by a convection fan motor 439. Further, convection fan 438 can be a variable speed fan—meaning the speed of fan 438 may be controlled or set anywhere between and including, e.g., zero and one hundred percent (0% -100%). In certain embodiments, oven appliance 400 may also include a bidirectional triode thyristor (not shown), i.e., a triode for alternating current (TRIAC), to regulate the operation of convection fan 438 such that the speed of fan 438 may be adjusted during operation of oven appliance 400. The speed of convection fan 438 can be determined by controller 210 (not specifically illustrated in FIGS. 6 and 7, but which is similar to the controllers 210 described above). In addition, a sensor 437 such as, e.g., a rotary encoder, a Hall effect sensor, or the like, may be included at the base of fan 438, for example, between fan 438 and motor 439 as shown in the exemplary embodiment of FIG. 7, to sense the speed of fan 438. The speed of fan 438 may be measured in, e.g., revolutions per minute (“RPM”). In some embodiments, the convection fan 438 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity. Additionally, the convection heating features are optional and are shown and described herein solely by way of example. In other embodiments the oven appliance 400 may include different convection heating features or may not include convection heating features at all.

In various embodiments, more than one convection heater, e.g., more than one convection heating elements 436 and/or convection fans 438, may be provided. In such embodiments, the number of convection fans and convection heaters may be the same or may differ, e.g., more than one convection heating element 436 may be associated with a single convection fan 438. Similarly, more than one top heating element 424 and/or more than one bottom heating element 426 may be provided in various combinations, e.g., one top heating element 424 with two or more bottom heating elements 426, two or more bottom heating elements 426 with no top heating element 424, etc.

Oven appliance 400 includes a user interface 164 having a display 104 positioned on an interface panel 100 and having a variety of controls 102. Interface 164 allows the user to select various options for the operation of oven 400 including, e.g., various cooking and cleaning cycles. Operation of oven appliance 400 can be regulated by a controller 210 that is operatively coupled to, i.e., in communication with, user interface 164, heating elements 424, 426, and other components of oven 400 as will be further described. In some embodiments, display 104 can also be used as an input device. For instance, in such embodiments, display 104 can be a touchscreen device. In some embodiments, display 104 is the only input device on interface panel 164, e.g., the controls 102 may be omitted and the input functionality may be provided by the touchscreen display 104.

For example, in response to user manipulation of the user interface 164, the controller can operate the heating element(s). The controller can receive measurements from one or more temperature sensors (not shown) which are in or in thermal communication with the cooking chamber 404. The controller may also provide information such as a status indicator, e.g., a temperature indication, to the user with display 104.

Although shown with touch type controls 102, it should be understood that controls 102 and the configuration of oven appliance 400 shown in FIGS. 6 and 7 is provided by way of example only. More specifically, user interface 164 may include various input components, such as one or more of a variety of electrical, mechanical, or electro-mechanical input devices including rotary dials, push buttons, and touch pads. User interface 164 may include other display components, such as a digital or analog display device designed to provide operational feedback to a user. User interface 164 may be in communication with the controller via one or more signal lines or shared communication busses.

The present invention could also be used with other cooking appliances such as, e.g., a wall over, a stand-alone oven, a cooktop, or other configurations of such cooking appliances. Numerous variations in the oven configuration are possible within the scope of the present subject matter. For example, variations in the type and/or layout of the controls 102 on the interface 164, as mentioned above, are possible. As another example, the oven appliance 400 may include multiple doors 408 instead of or in addition to the single door 408 illustrated. Such examples include a dual cavity oven, a French door oven, and others. As still another example, one or more of the illustrated heating elements may be substituted with microwave heating elements, or any other suitable heating elements. The examples described herein are provided by way of illustration only and without limitation.

According to various embodiments of the present disclosure, a home appliance may take the form of any of the examples described above, or may be any other home appliance where improved user responsiveness is desired. Thus, it will be understood that the present subject matter is not limited to any particular home appliance.

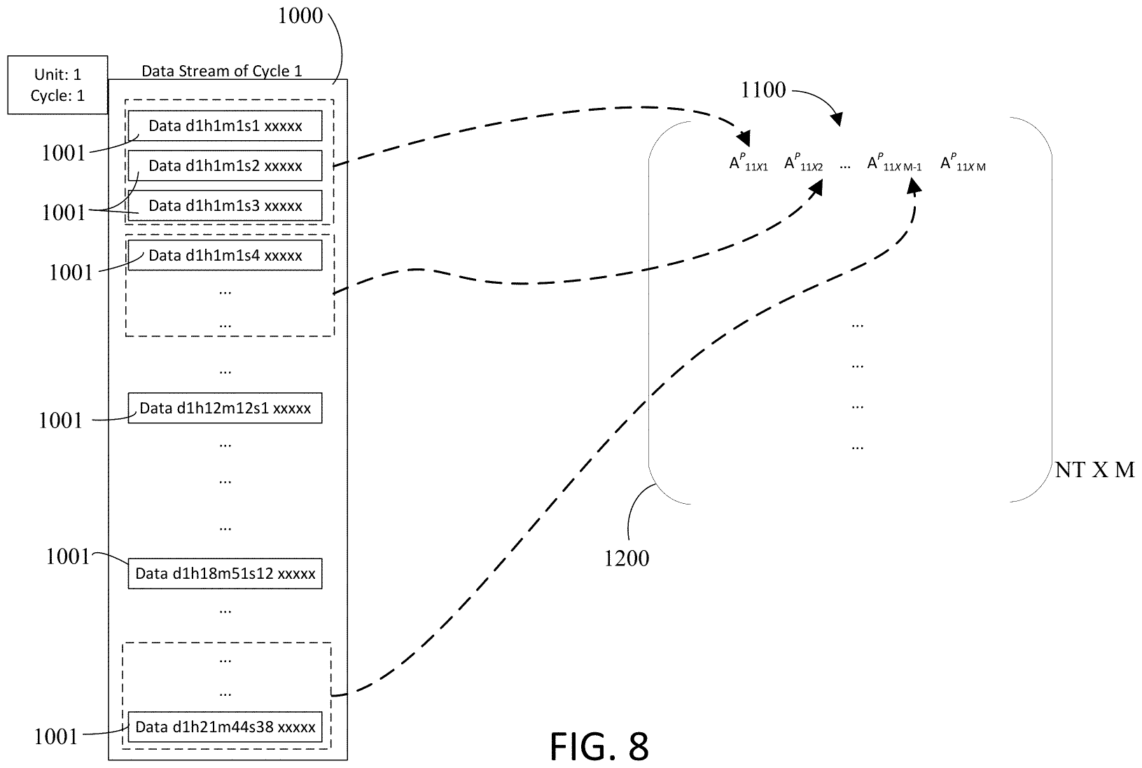

Turning now to FIG. 8, an appliance, e.g., a home appliance or unit, may generate a data stream 1000 during operation of the home appliance, such as during an exemplary operating cycle (e.g., “Cycle 1” as in FIG. 8) of the home appliance. The data stream 1000 may be processed, e.g., analyzed, while the operating cycle during which the data stream 1000 is being generated and to which the data stream 1000 pertains is ongoing, e.g., the data stream 1000 may be analyzed in real time. The home appliance may be one, e.g., a first one, of a plurality of home appliance, for example, the home appliance may be designated or referred to as “Unit 1,” e.g., as noted in FIG. 8. The data stream 1000 may include a plurality of data points 1001 which are generated, e.g., continuously generated, throughout the operating cycle, such as continuously throughout the entire operating cycle. Thus, for example, the data stream 1000 may include a first data point such as “Data d1h1m1s1 xxxxx,” which includes a time stamp, e.g., day 1, hour 1, minute 1, second 1, indicating the point in time during the operating cycle at which the data point 1001 was generated. The data points 1001 may also each include a value, which is indicated as “xxxxx,” in FIG. 8 and which may be any suitable value for the data point 1001. For example, the data points 1001 may each be or include sensor data, such as a reading or value captured by one or more sensors of the home appliance during the operating cycle, such as a temperature sensor, where the value of “xxxxx” may be a temperature reading in degrees, such as degrees Celsius, degrees Fahrenheit, etc. One or more of the data points 1001 may also or instead include parametric values, such as user-selected parameters, predetermined parameters, parameters automatically selected in response to a timer (such as a cycle timer of the operating cycle), and/or parameters automatically selected in response to a sensor reading (such as a water pressure level, a temperature, etc., where the selected parameter may be selected based on the sensor reading being greater than or less than a threshold), among other possible exemplary parametric values. The data points 1001 may also include entity resource designators (“ERDs”).

The home appliance that generates data stream 1000 may be any home appliance within the meaning of such term as discussed herein, e.g., an appliance which performs one or more domestic tasks such as an air conditioner, water heater, refrigerator, laundry appliance, etc. Such home appliances may include one or more instruments capable of producing data points 1001. For example, a home appliance may include at least one of a camera capable of capturing images of the appliance (e.g., an interior thereof), a microphone capable of capturing an audio signal (e.g., an alarm, a knock, etc.), or a sensor configured to measure various attributes of the appliance (e.g., a temperature sensor, a humidity sensor, a pressure sensor, a door sensor, etc.). Some embodiments may include a combination of the above-mentioned instruments, and/or additional instruments.

As illustrated in FIG. 8, the data stream 1000 may include a plurality of data points 1001 that are continuously generated throughout the operating cycle, such as at least once every second throughout the operating cycle. For example, after the first data point 1001 having a time stamp of “d1h1m1s1,” the next data point 1001 may follow one second later, and thus have a time stamp of “d1h1m1s2,” indicating that the next data point 1001 was captured at second two of the first operating cycle. This data point 1001 may then be followed by subsequent data points 1001, e.g., at second three, second four, etc., as indicated in FIG. 8. Not all data points 1001 in data stream 1000 are specifically illustrated in FIG. 8 for purposes of clarity and concision. Thus, the ellipses in data stream 1000 indicate intermediate data points which are not specifically illustrated, such as data points at second five and second six of minute one, data points at minute two, and so on. Additional exemplary and non-limiting data points 1001 are illustrated in FIG. 8 with timestamps “d1h12m12s1” (day one, hour twelve, minute twelve, and second one), “d1h18m51s12” (day one, hour eighteen, minute fifty one, and second twelve), and “d1h21m44s38” (day one, hour twenty one, minute forty four, and second thirty eight). Thus, it should be understood that each ellipsis in FIG. 8 may represent multiple intervening data points that are not specifically illustrated, such as one data point every second, between the exemplary data points 1001 which are included in the illustration in FIG. 8.

Also as illustrated in FIG. 8, the data stream 1000 may be used to construct an appliance performance result matrix 1200. For example, the data stream 1000 may be used to construct an appliance performance result vector 1100 for unit 1 and cycle 1. The appliance performance result vector 1100 and the appliance performance result matrix 1200 may be constructed in real-time, e.g., using real-time data, in a distributed computing environment, e.g., in a cloud environment. In some embodiments, the terms of the appliance performance result vector 1100 may generally take the form of A^{P}_{NT×M}. In such embodiments, N is the number of the unique appliance unit which generated the data, such as a MAC address, serial number, or other identifier, that represents a particular home appliance unit. In such embodiments, T is the number of the unique cycle, such as cycle one, cycle two, etc., and operation within the cycle, such as a preheat operation within a cooking cycle of a cooking appliance, a rinse operation within a wash cycle in a dishwashing appliance or laundry appliance (washing machine appliance), etc. Also in such embodiments, M is a designated number of specified data frame, input, and/or features for the operating cycle of the home appliance during which the data is generated.

In some embodiments, e.g., as illustrated in FIG. 8, the processing of the data stream 1000 in real time may be enhanced, e.g., accelerated, by combining, e.g., mathematically averaging the values of, multiple consecutive data points 1001 in each term of the appliance performance result vector 1100. For example, as illustrated in FIG. 8, each term of the appliance performance result vector 1100 may correspond to three data points 1001 and/or three seconds' worth of data. In additional embodiments, two consecutive data points 1001 may correspond to each term of the appliance performance result vector 1100, or more than three data points, etc.

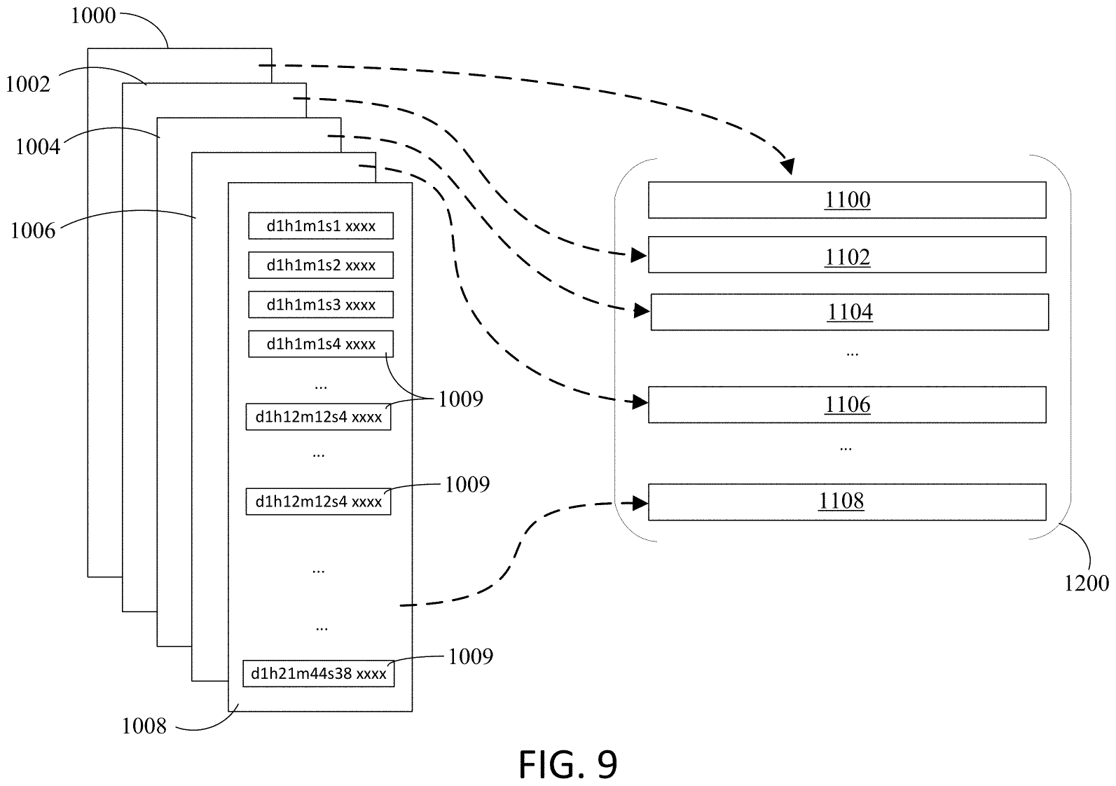

Turning now to FIG. 9, multiple data streams may be used to construct the appliance performance result matrix 1200. For example, as illustrated in FIG. 9, the appliance performance result matrix 1200 may be constructed from a first appliance performance result vector 1100 which is constructed from a first data stream 1000, a second appliance performance result vector 1102 which is constructed from a second data stream 1002, a third appliance performance result vector 1104 which is constructed from a third data stream 1004, a fourth appliance performance result vector 1106 which is constructed from a fourth data stream 1006, and a fifth appliance performance result vector 1108 which is constructed from a fifth data stream 1008. As mentioned above with respect to FIG. 8, the ellipses in the fifth data stream 1008 in FIG. 9 may each represent multiple additional data points in fifth data stream 1008 and the ellipses in the appliance performance result matrix 1200 may each represent multiple intermediate appliance performance result vectors (which are constructed from respective intermediate data streams, where the intermediate data streams are not specifically illustrated for the same reasons).

In various embodiments, the multiple data streams 1000, 1002, 1004, 1006, and 1008 may be generated by the same home appliance or by multiple home appliances. For example, the first data stream 1000 may be generated by a first home appliance (e.g., “Unit 1,” as noted in FIG. 8) during a first operating cycle (e.g., “Cycle 1,” as noted in FIG. 8) , and a later data stream, e.g., the second data stream 1002, may be generated by the first home appliance during a subsequent, e.g., second, operating cycle, while additional data streams, e.g., any one or more of the third data stream 1004, the fourth data stream 1006, and the fifth data stream 1008, may be generated by a different, e.g., second home appliance. Also by way of example, all of the data streams from which the appliance performance result matrix 1200 is constructed may be generated by the same home appliance, or each data stream may be generated by a different home appliance from every other data stream, or various combinations thereof

As mentioned above, the appliance performance result matrix 1200 may be constructed with multiple appliance performance result vectors, with each appliance performance result vector being constructed based on one corresponding data stream. Thus, while some exemplary fifth data points 1009 of fifth data stream 1008 are illustrated in FIG. 9, it should be understood that not all data points 1009 of the fifth data stream 1008 are included in FIG. 9 and that each of the other data streams includes a plurality of data points, where the data points from the first through fourth data streams 1000, 1002, 1004, 1006, and 1008 are omitted for the sake of clarity in the illustration of FIG. 9.

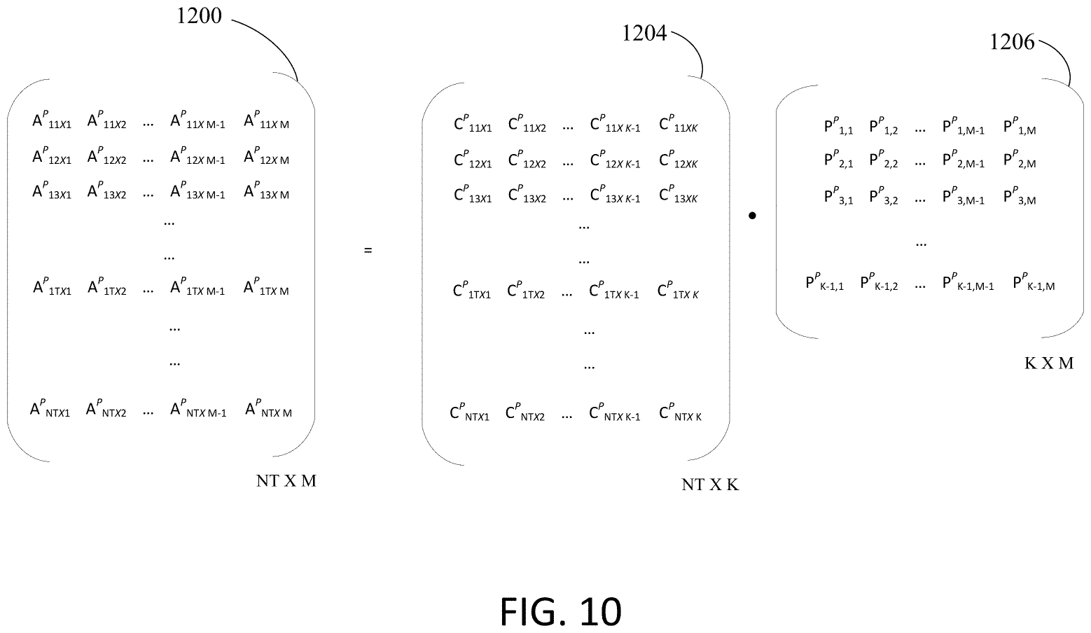

FIG. 10 illustrates an exemplary factorization of the appliance performance result matrix 1200 into two latent matrices. In some embodiments, the appliance performance result matrix 1200 may be the dot product of the two factor matrices, as indicated in FIG. 10. In the particular example illustrated in FIG. 10, the two latent matrices which are factorized from the appliance performance result matrix 1200 include an appliance cycle characteristics matrix 1204 and a performance grid matrix 1206. As may be seen, e.g., in FIG. 10, the appliance performance result matrix 1200 may be an NT by M matrix (where the N, T, and M terms may have the same meanings as described above with respect to the terms of the appliance performance result vector 1100), and may be factorized into an NT by K matrix (appliance cycle characteristics matrix 1204) and a K by M matrix (performance grid matrix 1206). In some embodiments, the matrix factorization may be performed by minimizing an objective function to deduce the appliance cycle characteristics matrix 1204 while holding the performance grid matrix 1206 constant. An exemplary objective formula in some such embodiments may include:

$$arg {min}_{{c}^{*} , {p}^{*}} {\sum }_{( c , p ) ∈ K} ( {r}_{c , p} - {c}_{i}^{T} {p}_{n} ) + λ ( {‖ {c}_{i} ‖}^{2} + {‖ {p}_{n} ‖}^{2} )$$

s. t.:
r_{c,p} is the appliance cycle performance result
cᵢ is the latent appliance cycle—specific characteristics
pₙ is the latent sensor performance result
λ is the L2 regularization term discount factor

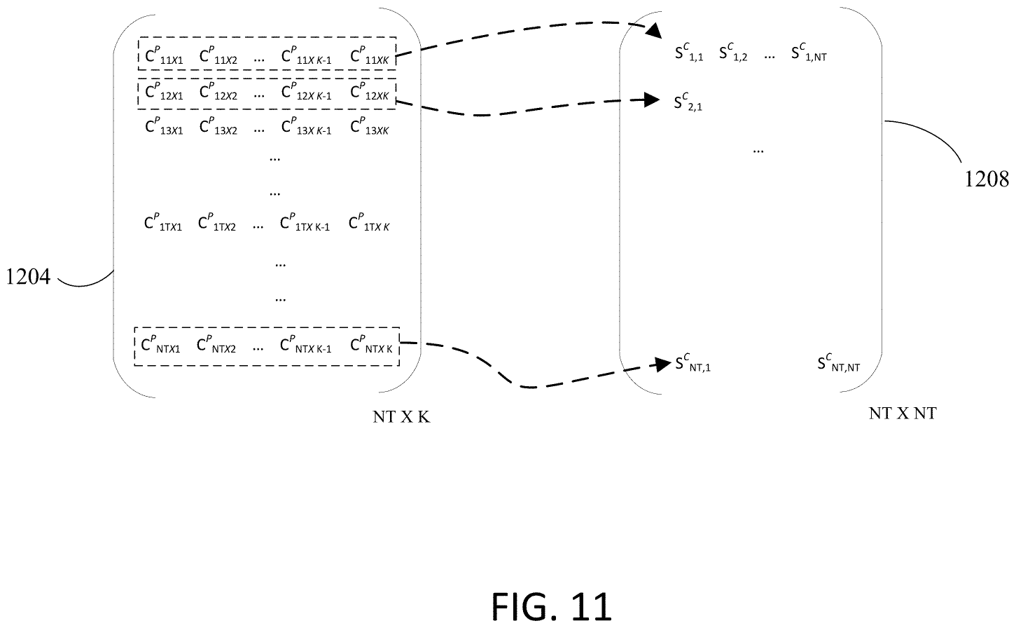

Turning now to FIG. 11, the deduced appliance cycle characteristics matrix 1204 may be used to calculate a unit cycle similarity matrix 1208. For example, the unit cycle similarity matrix 1208 may be calculated from the deduced appliance cycle characteristics matrix 1204 by applying a similarity formula to the appliance cycle characteristics matrix 1204. In some embodiments, the similarity formula may, for example, take a form such as:

$${S}_{{C}_{a ,} {C}_{b}} = cos ( \vec{{C}_{a}} , \vec{{C}_{b}} ) = \frac{{\vec{C}}_{a} \cdot {\vec{C}}_{b}}{‖ {\vec{C}}_{a} ‖ * ‖ {\vec{C}}_{b} ‖} = \frac{{x}_{1} {x}_{2} + {y}_{1} {y}_{2}}{\sqrt{{x}_{1}^{2} + {y}_{1}^{2}} \sqrt{{x}_{2}^{2} + {y}_{2}^{2}}}$$

Thus, the unit cycle similarity matrix 1208 may provide similarity based, e.g., neighborhood-based clustering, such as cycle based top N neighbor identification, for example. In some embodiments, the unit cycle similarity matrix 1208 may be used to identify similar home appliance operating cycles and group multiple operating cycles together based on similarity in the characteristics of respective operating cycles of the home appliances.

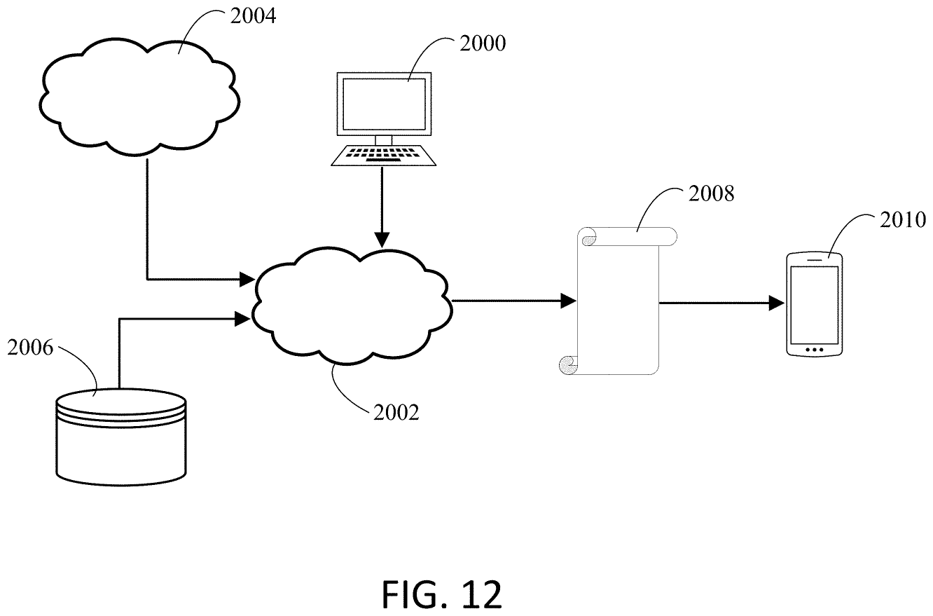

Turning now to FIG. 12, one such group of similar home appliance operating cycles may be in the form of a list 2008. FIG. 12 illustrates an exemplary system for monitoring a plurality of home appliances. As illustrated in FIG. 12, such system may include a terminal 2000 or other suitable input means whereupon a clustering schedule may be configured. For example, a user, e.g., technician or engineer, etc., may access the terminal 2000 to configure the clustering schedule on the terminal 2000. In such embodiments, the terminal 2000 may then transmit, e.g., upload, the clustering schedule to a cloud performance clustering system 2002.

The cloud performance clustering system 2002 may then pull in, e.g., download, all active data streams from a cloud 2004, where the cloud 2004 may include one or more distributed computing devices, such as one or more remote databases, remote severs, and/or additional remote computing devices, which are connected to a plurality of home appliances, e.g., the plurality of home appliances may transmit data, such as one or more exemplary data streams as described above in context of FIGS. 8 and 9, via the internet to the cloud 2004. The “active” data streams may include all streams for which real-time data is currently being received from the respective home appliance.

The cloud performance clustering system 2002 may also connect to an anomaly database 2006 and receive, e.g., download or access, data related to anomalous cycles from the anomaly database 2006. For example, where the plurality of home appliance are dishwashing appliances, the anomalous cycles may include cycles in which a filter of the dishwashing appliance was clogged. Associated data with such anomalous cycles may include, e.g., liquid levels or liquid pressure levels, such as in a sump of the dishwashing appliance, measured with a pressure sensor and transmitted (e.g., streamed, as described above) to the cloud 2004. Such data streams may be tagged as anomalous and entered into the anomaly database 2006 based on and/or in response to one or more of: consumer complaints, fault codes generated by the home appliance, ad-hoc cloud diagnostics, reports from repair personnel, and/or lab testing reports. The active data streams may then be compared to the anomalous cycles from the anomaly database 2006 in order to identify, e.g., in real time, potential faults or anomalies in the current, active, operating cycles of one or more home appliances from the plurality of home appliances which are connected to the cloud 2004. The cloud performance clustering system 2002 may then generate the list 2008 of most similar home appliance operating cycles, such as based on an appliance cycle characteristic matrix 1204, e.g., applying a similarity formula to the appliance cycle characteristic matrix 1204, as described above. For example, the list 2008 may include a ranked list of home appliance operating cycles, e.g., selected from the active data streams retrieved from the cloud 2004, which are ranked in order starting with the most similar to the anomalous cycles from the anomaly database 2006, e.g., from most to least similar, such as based on the similarity matrix 1208.

Once the list 2008 has been generated, one or more of the home appliances from which the data streams indicating a current operating cycle is similar to an anomalous cycle was received may be flagged for further action. For example, the top N most similar cycles, where N may be any number, such as top ten, top one hundred, top ten thousand, etc., or any percentage, such as top ten percent of the list 2008, top one percent, top thirty three percent, top five percent, or top twenty-five percent, etc., may be selected for further action (the foregoing stated examples are also each intended to include intermediate values between the stated examples, such that N may be any number or percentage encompassed within the range of examples given). Such further action may include sending a notice of one or more actionable items, e.g., repair or maintenance actions, to a user interface device, such as user interface device 2010. Referring again to the clogged filter in a dishwashing appliance example discussed above, the notification may be or include an instruction to clean the filter.

The user interface device 2010 may be a laptop computer, smartphone, tablet, personal computer, wearable device, smart home system, and/or various other suitable devices. Any suitable device that is configured to provide and/or receive communications, information, data, or commands from a user may serve as the user interface device 2010, such as a smartphone (e.g., as illustrated in FIG. 12), smart watch, personal computer, smart home system, or other similar device. The user interface device 2010 may include a memory for storing and retrieving programming instructions. For example, the user interface device 2010 may be a smartphone operable to store and run applications, also known as “apps,” and some or all of the method steps disclosed herein may be performed by a smartphone app and/or a user interface may be provided as a smartphone app.

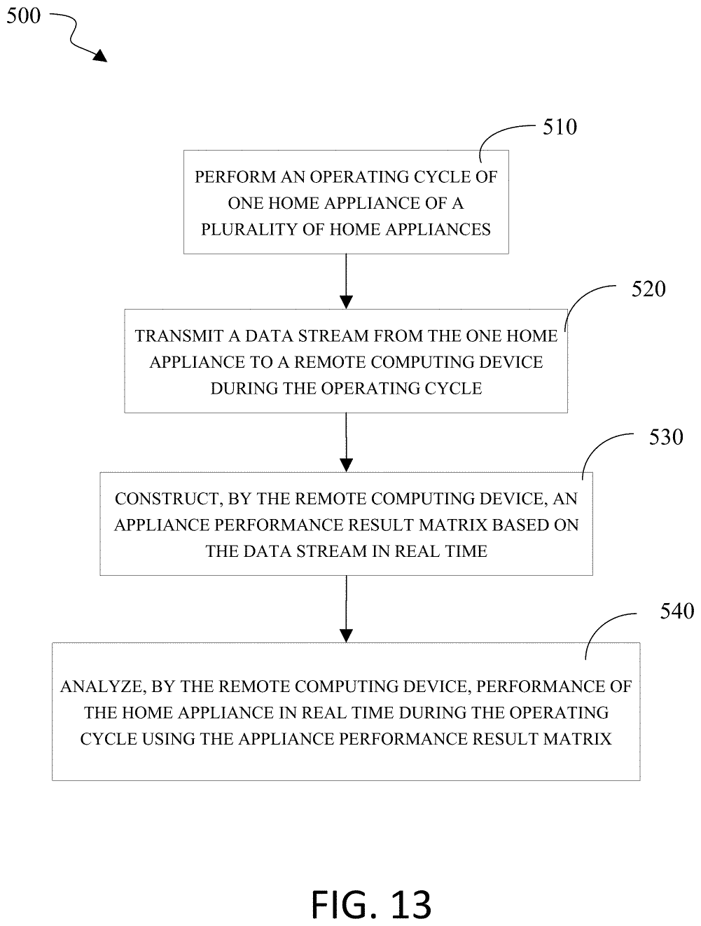

As illustrated in FIG. 13, embodiments of the present disclosure also include methods for monitoring a plurality of home appliances, where the home appliances may include any of the foregoing exemplary appliances, e.g., laundry appliance 10 or 11, dishwasher appliance 300, or oven appliance 400, described above. Further, methods of operating a home appliance according to the present disclosure are not necessarily limited to the exemplary appliances described or illustrated. For example, the cooking appliance may include various combinations of heating modules and/or heating elements as in any of the foregoing examples, such as an oven appliance with only electric radiant heating (e.g., without convection), an oven appliance with gas bake heating element and convection heating, an oven appliance with ceramic heating modules and heat lamps, among numerous other possible combinations.

The plurality of home appliances are generally the same type of home appliance and/or have common features, e.g., embodiments of the plurality of home appliances may include a plurality of washing machine appliances, a plurality of dryer appliances, and/or a plurality of dishwasher appliances, etc. For example, the plurality of home appliances may be a plurality of dishwasher appliances having similar drain pumps (or other pumps, etc.), similar filters, as well as other similar features, whereby an identified anomalous or faulty operating cycle, as will be described in more detail below, of one dishwasher appliance of the plurality of dishwasher appliances may be used to identify similar issues, e.g., a clogged filter or worn out drain pump, etc., in other dishwasher appliances of the plurality of dishwasher appliances.

In some embodiments, the plurality of home appliances may include any and all home appliances which are connected to the same remote computing device, e.g., remote database, such as connected to a cloud computing system or network. In such embodiments, the plurality of home appliances may also include diverse home appliances, such as oven appliances and dishwasher appliances may both be connected to the same cloud, where the operating cycles of such appliances (e.g., oven appliances as contrasted with dishwasher appliances) are sufficiently distinct in the data generated thereby and any resultant vectors and/or matrices created using such data are sufficiently distinct that analysis thereof, as described herein, would readily distinguish such diverse appliances. In some embodiments where the plurality of home appliances includes diverse home appliances, such as oven appliances and dishwasher appliances, remote computing devices, e.g., a cloud or distributed computing system, as mentioned, to which the plurality of home appliances are connected may be segregated or partitioned based on appliance type, e.g., dishwasher data may be stored in one database and oven data may be stored in another database or a separate partition within the same database.

Exemplary methods according to the present subject matter include the method 500 illustrated in FIG. 13. As illustrated in FIG. 13, the method 500 may include a step 510 of performing an operating cycle of a home appliance of the plurality of home appliances. Such operating cycle includes activating one or more components of the home appliance, such as a heating element, fan, pump, motor, or other physical component of the home appliance, which then acts upon another item of tangible matter, e.g., air, water, wash liquid, food items, etc., in various types of home appliances.

Method 500 may further include a step 520 of transmitting a data stream from the home appliance to a remote computing device during the operating cycle. For example, the data stream may be one of the data streams 1000, 1002, 1004, 1006, and 1008 and may include data points generated by one or more sensors or instruments in the home appliance, e.g., as described above with reference to FIGS. 8 and 9.

Still referring to FIG. 13, the method 500 may also include a step 530 of constructing an appliance performance result matrix based on the data stream in real time, e.g., while the operating cycle is ongoing. Step 530 may be performed by the remote computing device. In at least some embodiments, the operating cycle may be a current operating cycle of the home appliance. In such embodiments, constructing the appliance performance result matrix may include constructing an appliance performance result vector for the current operating cycle based on the transmitted data stream. For example, the appliance performance result matrix may include the appliance performance result vector for the current operating cycle and an appliance performance result vector for a prior operating cycle of the home appliance. The appliance performance result vector for the prior operating cycle of the home appliance may have been constructed in real time during the prior operating cycle and stored in the appliance performance result matrix. Thus, constructing the appliance performance result matrix may include updating an existing appliance performance result matrix with additional appliance performance result vectors for each data stream, including multiple data streams from different home appliances of the plurality of home appliances. As another example, in some embodiments, the appliance performance result matrix may also or instead include the appliance performance result vector for the current operating cycle and an appliance performance result vector for an operating cycle of a different home appliance of the plurality of home appliances (e.g., a home appliance of the plurality of home appliances other than the one home appliance of the plurality of home appliances that performed the operating cycle in step 510).

Method 500 may further include a step 540 of analyzing performance of the home appliance in real time during the operating cycle using the appliance performance result matrix. Analyzing step 540 may be performed by the remote computing device. Analyzing the performance in real time may advantageously promote earlier detection of anomalous or potentially anomalous operating cycles (e.g., faulty operating cycles) which may, in turn, permit preventive measure to be taken, e.g., by the home appliance (such as decelerating a wash basket of a washing machine appliance during a spin cycle or activating a filter cleaning cycle in a dishwasher appliance, among numerous other possible examples) or by a user in response to a notification on a user interface, e.g., as described above with regard to FIG. 12, to prevent such anomalous (e.g., faulty) operating cycles and/or reduce the effects of such cycles.

Such analysis may also include, in at least some embodiments, comparing the operating cycle to one or more other additional cycles, such as to identify similar operating cycles. For example, analyzing the performance of the home appliance may include identifying a cluster of operating cycles of home appliances of the plurality of home appliances having similar characteristics as the current operating cycle. In such embodiments, the cluster of operating cycles of home appliances of the plurality of home appliances may include operating cycles of one or more different home appliance of the plurality of home appliances, e.g., home appliances of the plurality of home appliances other than the one home appliance of the plurality of home appliances that performed the operating cycle in step 510 (and/or step 610, which is described further below).

In some embodiments, analyzing step 540 may include deriving one or more latent matrices, such as decomposing the appliance performance result matrix into one or more latent matrices, e.g., a first latent matrix and a second latent matrix. For example, such embodiments may include factorizing the appliance performance result matrix into a first latent matrix and a second latent matrix. The first and second latent matrices may include an individual appliance cycle characteristics matrix and a performance grid matrix, e.g., the first latent matrix may be a characteristics matrix of a cycle of the home appliance (such as appliance cycle characteristics matrix 1204 described above) and the second latent matrix may be a performance grid matrix of the cycle of the home appliance (such as performance grid matrix 1206 described above). The first latent matrix and the second latent matrix may each include therein all unique details of the cycle of the home appliance, such as all unique times, e.g., start time and stop time, sensor data, and operating parameters, etc., of the cycle of the home appliance.

In some embodiments, the method may also include identifying an ideal latent matrix by solving a target function to minimize an error of a loss function. For example, the error may be mean squared error (MSE) or root mean squared error (RMSE). Also by way of example, the target function optimization may include using a stochastic gradient descent approach.

Some embodiments may further include generating a similarity matrix using a plurality of characteristics vectors. In such embodiments, each characteristics vector may represent a single corresponding cycle of a home appliance of the plurality of home appliances, where the home appliance may be the same home appliance for each cycle, different home appliances of the plurality of home appliances for each cycle, or combinations thereof. The method may further include approximating, using the similarity matrix, nearest neighbors of each of the corresponding cycles. For example, the nearest neighbor for each cycle may be determined or approximated based on numerical proximity (e.g., a similarity score) within the similarity matrix of the characteristics vector representing the cycle to other characteristics vectors of the similarity matrix. Additionally, some embodiments may include, once the similarity matrix has been generated, identifying a cluster of appliance cycles that resembles an identified faulty operating cycle. Such cycles may be assigned a similarity score and/or identified based on a similarity score to the identified faulty operating cycle in order to identify the cluster. In such embodiments, the cluster of appliance cycles may be identified based on a threshold, e.g., prescribed by system engineers over the cloud, where any appliance operating cycles with a similarity score above the threshold are identified as faulty. Such embodiments may further include storing the selected operating cycles (e.g., the identified cluster of appliance cycles) in the remote computing device, and transmitting, by the remote computing device, user notifications to corresponding remote user interface devices associated with the one or more home appliances that performed the selected operating cycles. For example, each home appliance that performed one or more of the cycles in the cluster (such as each cycle having a similarity score to the identified faulty operating cycle greater than the prescribed threshold) may be associated with a user account in the cloud, and one or more remote user interface devices, e.g., smartphones, may also be associated with the same user account in the cloud, whereby the user notification may be sent to the remote user interface device associated with the user account in the cloud for the home appliance that performed one or more of the operating cycles in the cluster. Such embodiments may also include transmitting, by the remote computing device a list of the one or more home appliances that performed the selected operating cycles to a customer service center. For example, the customer service center may then contact consumers for inquiry and/or to schedule repairs and maintenances for the corresponding home appliances that performed one or more of the cycles in the cluster.

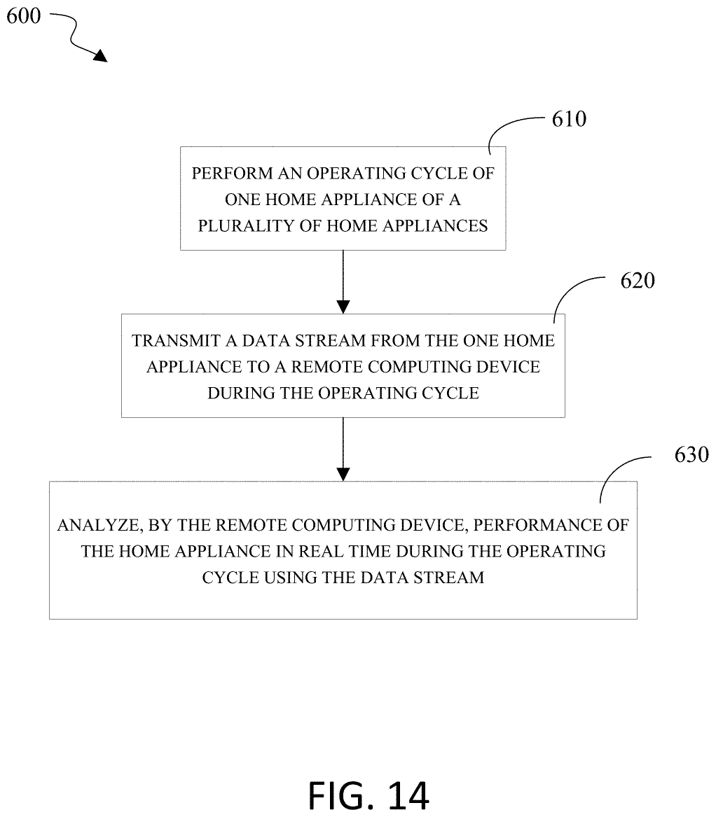

Turning now to FIG. 14, another exemplary method 600 of monitoring a plurality of home appliances is illustrated therein. The method 600 may include a step 610 of performing an operating cycle of a home appliance of the plurality of home appliances. Step 610 may be generally similar to step 510, which has already been described above. Method 600 may further include a step 620 of transmitting a data stream from the home appliance to a remote computing device during the operating cycle, which is also similar to step 520 of method 500 described above.

The method 600 may further include a step 630 of analyzing performance of the home appliance in real time during the operating cycle using the data stream. Such analysis may be performed by the remote computing device. Such analysis may include identifying potential anomalies in the operating cycle of the home appliance using any suitable analysis techniques.

In some embodiments, the analyzing step 630 of method 600 may include using the data stream to construct an appliance performance result matrix, e.g., constructing an appliance performance result matrix based on the data stream in real time. For example, the appliance performance result matrix may be constructed from one or more appliance performance result vectors, such as an appliance performance result vector constructed in real time from a data stream of a current operating cycle of the home appliance. The appliance performance result matrix may be constructed by the remote computing device.

Referring now generally to FIGS. 13 and 14, the methods 500 and/or 600 may be interrelated and/or may have one or more steps from one of the methods 500 and 600 combined with the other method 500 or 600. For example, in some embodiments of method 600, the appliance performance result matrix may be constructed using any of the steps and techniques described above regarding the appliance performance result matrix in method 500. Also by way of example, the analyzing step 630 of method 600 may include identifying a cluster of similar operating cycles, decomposing the appliance performance result matrix into one or more latent matrices, and/or identifying an ideal latent matrix, in a similar manner as described above in the context of the method 500. As yet another example, the method 600 may also include any one or more of the steps or processes described above with respect to method 500 in various combinations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of monitoring a plurality of home appliances, the method comprising:
performing an operating cycle of a home appliance of the plurality of home appliances;
transmitting a data stream from the home appliance to a remote computing device during the operating cycle, wherein the operating cycle is a current operating cycle;
constructing, by the remote computing device, an appliance performance result matrix based on the data stream in real time, wherein constructing the appliance performance result matrix comprises constructing an appliance performance result vector for the current operating cycle based on the transmitted data stream;
analyzing, by the remote computing device, performance of the home appliance in real time during the operating cycle using the appliance performance result matrix, wherein analyzing the performance of the home appliance using the appliance performance result matrix comprises decomposing the appliance performance result matrix into a first latent matrix and a second latent matrix, wherein analyzing the performance of the home appliance comprises identifying a cluster of operating cycles of home appliances of the plurality of home appliances having similar characteristics as the current operating cycle, wherein the cluster of operating cycles of home appliances of the plurality of home appliances having similar characteristics as the current operating cycle comprises anomalous cycles from an anomaly database, the anomaly database comprising data streams tagged as anomalous based on fault codes generated by respective home appliances; and
taking a preventive measure by the home appliance.

2. (canceled)

3. The method of claim 1, wherein the appliance performance result matrix comprises the appliance performance result vector for the current operating cycle and an appliance performance result vector for a prior operating cycle of the home appliance.

4. The method of claim 1, wherein the appliance performance result matrix comprises the appliance performance result vector for the current operating cycle and an appliance performance result vector for an operating cycle of a different home appliance of the plurality of home appliances.

5. The method of claim 4, wherein the cluster of operating cycles of home appliances of the plurality of home appliances includes operating cycles of the different home appliance of the plurality of home appliances.

6. The method of claim 1, wherein the first latent matrix is a characteristics matrix of a cycle of the home appliance and the second latent matrix is a performance grid matrix of the cycle of the home appliance.

7. The method of claim 1, further comprising identifying an ideal latent matrix by solving a target function to minimize an error of a loss function and generating a similarity matrix using a plurality of characteristics vectors, wherein each characteristics vector of the plurality of characteristics vectors represents a corresponding cycle of a home appliance of the plurality of home appliances, and approximating, using the similarity matrix, nearest neighbors of each of the corresponding cycles.

8. A method of monitoring a plurality of home appliances, the method comprising:
performing an operating cycle of a home appliance of the plurality of home appliances;
transmitting a data stream from the home appliance to a remote computing device during the operating cycle;
analyzing, by the remote computing device, performance of the home appliance in real time during the operating cycle using the data stream, wherein analyzing the performance of the home appliance comprises identifying a cluster of operating cycles of home appliances of the plurality of home appliances having similar characteristics as the current operating cycle, wherein the cluster of operating cycles of home appliances of the plurality of home appliances having similar characteristics as the current operating cycle comprises anomalous cycles from an anomaly database, the anomaly database comprising data streams tagged as anomalous based on fault codes generated by respective home appliances; and
taking a preventive measure by the home appliance.

9. The method of claim 8, wherein analyzing performance of the home appliance in real time during the operating cycle using the data stream comprises constructing, by the remote computing device, an appliance performance result matrix based on the data stream in real time and analyzing the performance of the home appliance using the appliance performance result matrix.

10. The method of claim 9, wherein the operating cycle is a current operating cycle, and wherein constructing the appliance performance result matrix comprises constructing an appliance performance result vector for the current operating cycle based on the transmitted data stream.

11. The method of claim 10, wherein the appliance performance result matrix comprises the appliance performance result vector for the current operating cycle and one or more appliance performance result vectors for one or more prior operating cycles of the home appliance.

12. The method of claim 10, wherein the appliance performance result matrix comprises the appliance performance result vector for the current operating cycle and one or more appliance performance result vectors for one or more operating cycles of a different home appliance of the plurality of home appliances.

13. The method of claim 12, wherein the cluster of operating cycles of home appliances of the plurality of home appliances includes operating cycles of the different home appliance of the plurality of home appliances.

14. The method of claim 9, wherein analyzing the performance of the home appliance using the appliance performance result matrix comprises decomposing the appliance performance result matrix into a first latent matrix and a second latent matrix.

15. The method of claim 14, wherein the first latent matrix is a characteristics matrix of a cycle of the home appliance and the second latent matrix is a performance grid matrix of the cycle of the home appliance.

16. (canceled)

17. (canceled)

18. (canceled)

19. (canceled)

20. (canceled)

21. The method of claim 1, further comprising deducing an appliance cycle characteristics matrix, and calculating a unit cycle similarity matrix using the deduced appliance cycle characteristics matrix, wherein the cluster of operating cycles of home appliances of the plurality of home appliances having similar characteristics as the current operating cycle is identified based on the calculated unit cycle similarity matrix.

22. (canceled)

23. (canceled)

24. The method of claim 8, further comprising:
generating a similarity matrix using a plurality of characteristics vectors, wherein each characteristics vector of the plurality of characteristics vectors represents a corresponding cycle of a home appliance of the plurality of home appliances;
approximating, using the similarity matrix, nearest neighbors of each of the corresponding cycles;
identifying, after generating the similarity matrix, a cluster of operating cycles of one or more home appliances of the plurality of home appliances resembling an identified faulty operating cycle;
determining a similarity score for each operating cycle of the identified cluster of operating cycles; and
selecting operating cycles from the identified cluster of operating cycles based on the similarity score thereof being greater than a threshold.

25. The method of claim 24, further comprising storing the selected operating cycles in the remote computing device, and transmitting, by the remote computing device, user notifications to corresponding remote user interface devices associated with the one or more home appliances that performed the selected operating cycles.

26. The method of claim 25, further comprising transmitting, by the remote computing device, a list of the one or more home appliances that performed the selected operating cycles to a customer service center.
